(19) United States
(12) Patent Application Publication
(10) Pub. No.: US 2014/0278498 A1
(43) Pub. Date: Sep. 18, 2014

(54) SOCIAL NETWORK FOR MEDICAL PROFESSIONALS

(71) Applicant: Compliant Innovations, LLC, Los Altos, CA (US)

(72) Inventors: Sy Fahimi, Los Altos, CA (US); Kenneth B. Trauner, San Francisco, CA (US); Samuel Ethiopia, Santa Clara, CA (US)

(73) Assignee: Compliant Innovations, LLC, Los Altos, CA (US)

(21) Appl. No.: 14/211,131

(22) Filed: Mar. 14, 2014

Related U.S. Application Data
(60) Provisional application No. 61/798,823, filed on Mar. 15, 2013.

(51) Int. Cl. G06Q 50/22; G06Q 50/00; G06Q 10/10

(52) U.S. Cl. CPC G06Q 50/22; G06Q 10/10; G06Q 50/01
USPC 705/2

(57) ABSTRACT

A social network for medical professionals allows medical professionals a means for reviewing, sharing and organizing documents, images and communications, Information is made available and actions are conducted through a web portal. Actions available through the social network include finding and inviting other medical professionals, uploading images, videos, and documents, reading and sending secure messages, creating or participating on networks, posting or consuming targeted articles.

### CROSS REFERENCE TO RELATED APPLICATIONS

This application claims priority to U.S. Provisional Application No. 61/798,823, “SOCIAL NETWORK FOR MEDICAL PROFESSIONALS” filed Mar. 15, 2013, the contents of which are hereby incorporated by reference in its entirety.

### SUMMARY OF THE INVENTION

In various embodiments, a method for facilitating social network interaction among online users over a computer network using a web browser. The method can use a server computer to provide a graphical user interface that is accessible by users of multiple computers on the network. The graphical user interface can have a drawing portion that includes a quick connect tool for creating messages to network users. The method can also use the server computer to upload medical images to a secure database.

### BRIEF DESCRIPTION OF THE DRAWINGS

FIG. 1, illustrates an embodiment of a flow chart showing system features available through a web portal; and

FIG. 2, illustrates a block diagram of an embodiment of the inventive system.

### DETAILED DESCRIPTION

The present invention is directed towards an internet based social network for medical professionals including: doctors, nurses, pharmacists, physical therapists, drug company representatives, etc. The social network can be configured to allow medical professionals an intuitive and simplified means for reviewing, sharing and organizing documents, images and communications. The inventive system can include a server based website which users can log onto, as well as apps for mobile phones and other electronic devices.

The social network can be organized into groups based upon medical practice areas. For example, orthopedic physicians can have a professional circle of contacts who are all knowledgeable or interested in orthopedics. The inventive system can allow users to share information by uploading articles, documents, images, and sharing these with some or all of the people in their professional circle. In addition to professional circles, the users can configure their system with circles of friends, family, coworkers, etc.

In an embodiment, this communication can be performed through an instant messaging type page on the website or app. The IM-chat happens in real-time and can also permit messages to be sent to users not then logged on. These can be sent as offline messages and received when the user logs back into the system. In addition to text, the users can forward documents, links, images, etc.

In an embodiment, certain member groups may be interested in communicating with specific medical professional groups. For example, drug representative members or groups may be very interested in marketing his company's product to groups of doctors who have a choice in prescribing the company's product or a competing product. In an embodiment, the system may be configured to prevent unwanted sales communications. from the drug representatives to the groups of physicians. However, if permissions are granted the system can allow restricted communications based upon permissions granted by each of the individual members before the system would allow solicitations or communications.

In some embodiment, the medical professionals may wish to share patient information. However, due to patient confidentiality, it can be important to remove any patient identification information from the shared or distributed information. For example, if a doctor wishes to share a photograph or x-ray of a patient, the doctor must first remove all identification information. The inventive system can include an image editing system that allows users to redact or obscure text or other markings that may identify the patient. Once the editing is performed, the image can be posted and distributed in various ways. In addition to being an attachment to a message, the image can also be posted in a photo gallery portion of the system that can be a collection of images from one or more users.

In an embodiment, the user interface can illustrate a plurality of images in a predefined page or area of the website or application. The users can view the images with patient identification removed. If the user finds an image of interest, the user can select the image and the system can provide more information about the image. In an embodiment, each image can be similar to a “baseball trading card.” The displayed image may appear to flip over when selected and information about the image can be listed which may include the medical condition of the patient, the treatment applied to the patient, indicators in the image of the medical condition, possible treatments, likelihood of success of the treatment, doctor contact information, general patient information such as gender, ethnicity, age, etc. The physicians can look at many images and attempt to identify the condition, treatment, etc, based purely on the images.

With reference to FIG. 1, a flow chart showing the possible features, information and actions available through a web portal is illustrated. A user can log into a website and the system may ask the user if he or she is a physician 105. If the user is a physician, the system can display a daily physician overview and quick connect menu 111 on the user's web browser 103. In an embodiment, the Daily Physician Overview can include a Dashboard showing, recent messages, network posts, and new contacts that added the user as a colleague. In an embodiment, the Quick Connect can include a list of contacts the user frequently interacts with. The Quick Connect allows the user to easily send a secure message to any of the listed contacts.

From the overview 107, the user can find and invite Other Physicians and Medical Device Representatives 109 through the network. For example, the website an allow users to add other physicians from a centralized directory, find medical device representatives by company, request a medical representative, and create a circle for the user's practice, colleagues, and work groups.

The inventive system can include a database that can be a virtual cabinet, which allows the user to upload images, video, and documents to a secure storage database 111. The users can then access and share the images, video, and documents via message, network, and podium. The system can provide messaging capabilities that allow users to receive and send internal message as well as send secure external messages to non-members. For example, in an embodiment users can interact with a medical device representative on upcoming surgeries.

The inventive system can allow users to create and/or participate with turn-key networks 115. These networks can allow users to easily collaborate on medical cases. The system can easily add members and store case materials including: images, video and documents, etc. The inventive system can also provide a virtual podium for users to post and/or consume targeted articles by preference 117. Users can have the ability to securely broadcast audio video/text and consume journals and cases. In an embodiment, the podium information can be stored in a database and the desired information can be searched and retrieved by preferred keyword, specialty, and colleagues that the users are connected with

If the user is not a physician, the system can direct the user's browser 103 to a daily Non-Physician Overview and Quick Connect 121. The non-physicians can include medical device and pharmaceutical representatives. The Daily Non-Physician Overview and Quick Connect 121 can show recent messages, network posts, and new contacts that added the user as a colleague. In an embodiment, the Quick Connect 121 feature can generate a list of contacts that the user frequently interacts with in order to easily send secure messages to.

The user is browser 103 can proceed from the overview and quick connect 121 to various other system features. In an embodiment, the system can provide a means for sending invitations to connect with physicians and other medical peers 123. The feature can allow users to send a digital business card based invitation to physicians from a centralized directory, affiliate with a company directory to connect with other peers, and create a circle of customers, colleagues, and work groups. The system can also provide a virtual storage cabinet. Users can upload images, video, and documents to a secure storage 125. The users can then easily access and share the uploaded images, video, and documents via message, network, and podium. The non-physician users can also use the system to receive and send internal message as well as send secure external messages 127 to non-members. These communications can allow the non-physician users to interact with physicians on upcoming surgery. The inventive system also has the ability to create a turn-key network 129 to educate a physician on recent developments or technology; add members and materials images, video and documents.

With reference to FIG. 2, a block diagram of an embodiment of the inventive system 150 is illustrated. The system 150 can include a system server 155 that includes a file cabinet database 157, a physician database 159 and a non-physician database 161. The file cabinet database 157 can store uploaded images, video, documents and other information. The physician database 159 can store personal information for each of the physician system members. The non-physician database 161 can store personal information for each of the non-physician system members. The system server 155 can be coupled to a network 153, which can be the internet or any other network. The client computers 151 can each include a web browser which allows the client computers 151 to display web page user interfaces from the system server 155.

It will be understood that the inventive system has been described with reference to particular embodiments, however additions, deletions and changes could be made to these embodiments without departing from the scope of the inventive system. Although the systems that have been described include various components, it is well understood that these components and the described configuration can be modified and rearranged in various other configurations.

What is claimed is:

1. A method for facilitating social network interaction among online users over to computer network using a web browser, the method comprising:
providing, by a server computer, a graphical user interface that is separately and simultaneously accessible by users of a plurality of client computers on the network, the graphical user interface having a drawing portion that includes a quick connect tool for creating messages to the users; and
receiving, by the server computer, uploaded medical images to a secure database.
